(19) United States
(12) Patent Application Publication
(10) Pub. No.: US 2007/0156691 A1
(43) Pub. Date: Jul. 5, 2007

(54) Management of user access to objects

(75) Inventors: James Richard Sturms, Seattle, WA (US); Dennis Rakhamimov, Redmond, WA (US); Ziyi Wang, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/325,930

(22) Filed: Jan. 5, 2006

(51) Int. Cl. G06F 17/30

(52) U.S. Cl. 707/9

(57) ABSTRACT

Implementations of various technologies, including methods, systems and apparatus, for managing a request from a user to access an object. In one implementation, a determination is made as to whether the user is denied or granted access to the object based on a policy (step a). If the user is neither denied nor granted access to the object by the policy, then a determination is made as to whether the user is granted access to the object by an access control list (ACL) for the object (step b). A conclusion is then made as to whether the user has access to the object as determined by steps (a) and (b).

### BACKGROUND

When handling information, it is often desirable to limit access to specific portions of the information such that the specific portions are only accessible to certain authorized users. When information is contained in physical documents (e.g., printed book or ledgers), those documents can be secured using physical access controls such as locks and document custodians. However, in today's world, large amounts of information are stored in the form of digital data. Digital data may be easily created, modified, copied, transported and deleted, which leads to the proliferation of vast amounts of digital data existing in a myriad of locations. Similar to physical documents, it is often desirable to limit access to portions of digital data. However, the sheer amount of digital data and ease of creating, copying, transporting, modifying, and deleting digital data make securing digital data challenging.

Digital data may commonly be stored in file structures. A file structure may be a hierarchal system of data storage, in which objects containing digital data may be stored in folders. An object may be a program, a process, a file or an event. An object may also have a security descriptor. Folders may be further stored in other folders. The digital data in the object may be accessed in a per item manner.

For a given file structure, an access control list (ACL) may be assigned to each object, wherein the ACL is a data structure that indicates to a computer's operating system which permissions or access rights each user of the computer has to a given object. An ACL may specify that a particular user or group of users has certain permissions, such as read, write or execute permissions. Thus, in response to a request to access an object, the ACL for the object may be accessed to determine the permissions assigned to the object.

A system administrator may alter default security permissions defined in the ACL based on access requirements for a particular object. Considering that there may be hundreds, thousands, or even millions of objects, the process of reviewing the ACL for each object may be cost prohibitive and tedious.

Further, nesting of groups makes it difficult for a system administrator to ensure that only the appropriate users have permissions. For example, if an ACL contains an entry for a group of users, all users in this group are granted permissions, including groups within groups. Accordingly, it may be difficult for system administrators to ensure that a specific user or group of users does not have permissions on an object.

### SUMMARY

Described here are implementations of various technologies for managing a request from a user to access an object. In one implementation, a determination is made as to whether the user is denied or granted access to the object based on a policy (step a). If the user is neither denied nor granted access to the object by the policy, then a determination is made as to whether the user is granted access to the object by an access control list (ACL) for the object (step b). A conclusion is then made as to whether the user has access to the object as determined by steps (a) and (b).

In another implementation, a determination is made as to whether the user is denied or granted access to a server that contains the object.

In yet another implementation, the server is a virtual server.

In still another implementation, if the user is denied access to the server by the policy, then the user is denied access the object, even if the user is granted access to the object by the ACL.

In still yet another implementation, if the user is granted access to the server by the policy, then the user is granted access the object, even if the user has not been granted access to the object by the ACL.

Implementations of various technologies are also directed to a computer-readable medium having stored thereon computer-executable instructions which, when executed by a computer, cause the computer to: (a) determine whether a policy for a server containing an object denies or grants a user access to the server, (b) if the policy neither denies nor grants the user access to the server, then determine whether an access control list for the object grants the user access the object and (c) grants or denies the user access to the object based on steps (a) and (b).

Implementations of various technologies are also directed to a memory for storing data for access by an application program being executed on a processor. The memory has a data structure stored in the memory. The data structure includes an access mask for a server. The access mask specifies one or more permissions for granting or denying access to the server.

The claimed subject matter is not limited to implementations that solve any or all of the noted disadvantages. Further, this summary section is provided to introduce a selection of concepts in a simplified form that are further described below in the detailed description section. This summary section is not intended to identify key features or essential features of the claimed subject matter, nor is it intended to be used to limit the scope of the claimed subject matter.

### BRIEF DESCRIPTION OF THE DRAWINGS

FIG. 1 illustrates a schematic diagram of a network environment in which technologies described herein may be incorporated and practiced.

FIG. 2 illustrates a flow diagram of a method for managing access to one or more objects in accordance with the technologies described herein.

FIG. 3 illustrates a flow diagram of how various implementations of the technologies described herein may generate an effective set of permissions by merging the policy access mask with the ACL access mask.

### DETAILED DESCRIPTION

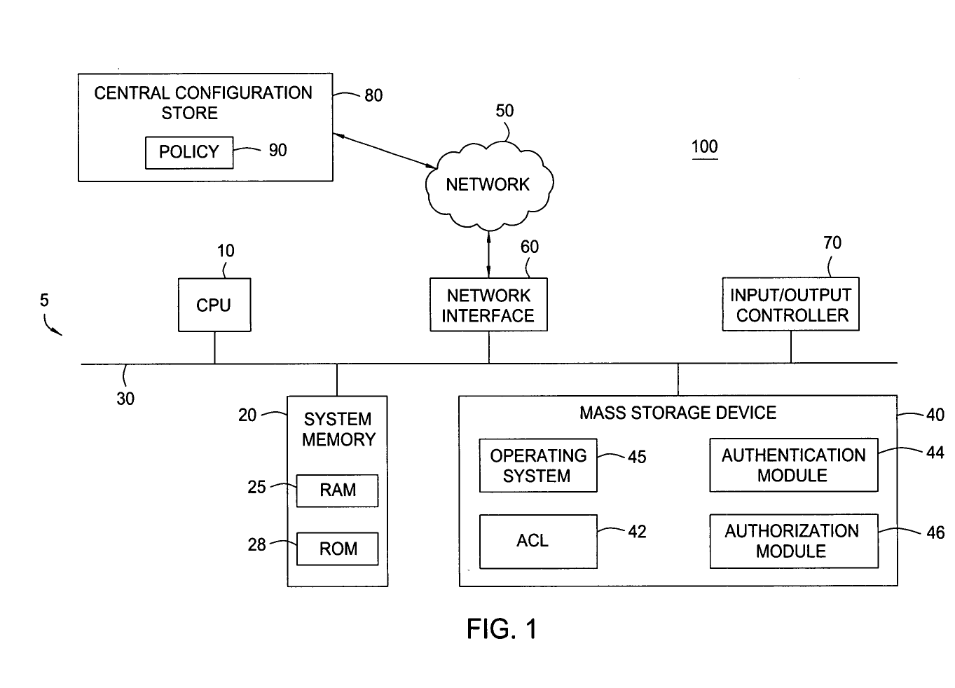

FIG. 1 illustrates a schematic diagram of a network environment 100 in which technologies described herein may be incorporated and practiced. The network environment 100 may include a conventional desktop or a server computer 5, which includes a central processing unit (CPU) 10, a system memory 20 and a system bus 30 that couples the system memory 20 to the CPU 10. The system memory 20 may include a random access memory (RAM) 25 and a read-only memory (ROM) 28. A basic input/output system containing the basic routines that help to transfer information between components within the computer, such as during startup, may be stored in the ROM 28. The computing system 5 may further include a mass storage device 40 for storing an operating system 45, application programs, and other program modules, which will be described in greater detail below.

Those skilled in the art will appreciate that various implementations of the technologies described herein may be practiced in other computer system configurations, including hypertext transfer protocol (HTTP) servers, hand-held devices, multiprocessor systems, microprocessor-based or programmable consumer electronics, network PCs, minicomputers, mainframe computers, and the like. Implementations of various technologies described herein may also be practiced in distributed computing environments where tasks are performed by local and remote processing devices that are linked through a communications network, e.g., by hardwired links, wireless links, or combinations thereof. In a distributed computing environment, program modules may be located in both local and remote memory storage devices.

The mass storage device 40 may be connected to the CPU 10 through the system bus 30 and a mass storage controller (not shown). The mass storage device 40 and its associated computer-readable media are configured to provide non-volatile storage for the computing system 5. Although the description of computer-readable media contained herein refers to a mass storage device, such as a hard disk or CD-ROM drive, it should be appreciated by those skilled in the art that computer-readable media may be any available media that can be accessed by the computing system 5. For example, computer-readable media may include computer storage media and communication media. Computer storage media includes volatile and non-volatile, and removable and non-removable media implemented in any method or technology for storage of information such as computer-readable instructions, data structures, program modules or other data. Computer storage media further includes, but is not limited to, RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 5.

As briefly mentioned above, the mass storage device 40 may include the operating system 45, which is suitable for controlling the operation of a networked personal or server computer. The operating system 45 may be Windows® XP, Mac OS® X, Unix-variants, like Linux® and BSD®, and the like. The mass storage device 40 may also include one or more access control lists (ACL) 42 that are used to determine the rights users may have to objects in the mass storage device 40. Although only a single ACL is illustrated in FIG. 1, it should be understood that the ACL 42 may represent several ACLs, each ACL granting one or more users rights to an object associated with that ACL. Objects may commonly be referred to as items or resources. An object may be a program, a process, a file, an event or anything else having a security descriptor. Each ACL may include a data structure, usually a table, containing access control entries (ACEs) that specify user or group rights to a given object. Each ACE contains the security identifier for a user or group and an access mask that specifies which operations by the user or group are allowed or denied. An access mask may contain a value that specifies the permissions that are allowed or denied in an ACE of an ACL.

As briefly mentioned above, the mass storage device 40 may include program modules. Program modules generally include routines, programs, components, data structures and other types of structures that perform particular tasks or implement particular abstract data types. Typically, the functionality of the program modules may be combined or distributed as desired in various implementations.

In one implementation, the mass storage device 40 includes an authentication module 44 and an authorization module 46. The authentication module 44 is configured to verify the identity of a user. For example, the user may be identified by a number of security identifiers (SIDs), wherein each SID is a data structure of variable length that identifies a user or various groups of which the user is a member. As such, the authentication module 44 may access a database of authentication information having information against which the SIDs are to be compared. The authentication information database (not shown) may be stored in the mass storage device 40. Various implementations of the technologies described herein are not limited by the use of SIDs, i.e., the identity of the user may be identified using other types of identifiers, such as passwords, certificates, biometrics and the like. The authentication process may be any authentication technique, including a standard authentication technique, such as the Kerebos authentication technique in which a Kerebos client of the user's computer system provides a user name and password to a Kerebos server of the administrator domain. The Kerebos server validates the user name and password, ensures that the user has the allowed-to-authenticate access rights to the requested computer system, and if so, provides a “ticket” to the user. That ticket is used whenever that user attempts to access an object of the computer system to which it has been authenticated. If the ticket is valid, then access to the object may be determined and authorized in accordance with the ACL of the object and the policy of the system that contains the object. If not, access is denied. This determination and authorization process will be described in more detail in the paragraphs below. In one implementation, once the identity of the user has been authenticated, the user's rights to access the object may be determined by the authorization module 46, which will also be described in more detail in the paragraphs below.

Either the authentication module 44 or the authorization module 46 or both may be any type of programmable codes, such as dynamic link library (DLL), which is generally defined as an executable code module that can be loaded on demand and linked at run time, and then unloaded when the code is no longer needed, dynamic shared objects, and the like.

As illustrated in FIG. 1, the computing system 5 may operate in the network environment 100 using logical connections to remote computers through a network 50, such as the Internet, an intranet or an extranet. The computing system 5 may connect to the network 50 through a network interface unit 60 connected to the system bus 30. It should be appreciated that the network interface unit 60 may also be used to connect to other types of networks and remote computer systems. The computing system 5 may also include an input/output controller 70 for receiving and processing input from a number of other devices, including a keyboard, mouse, or electronic stylus (not shown). The input/output controller 70 may also provide output to a display screen, a printer, or other types of output devices.

In one implementation, the computing system 5 is coupled to a central configuration store 80, which contains a policy 90. The policy 90 contains a set of security protections that may be applied throughout the computer system 5. As such, the policy 90 may contain a set of ACEs, wherein each ACE may contain the security identifier for a user or group and an access mask that specifies which operations by the user or group are granted or denied. In one implementation, the policy may contain a set of grant access masks and a set of deny access masks for a predetermined set of users and/or groups that may have access to the computer system 5. Granting a right in the policy gives that right to a user or group on all secured objects within the system 5 regardless of the permissions defined by the ACL for that object. Similarly, denying a right in the policy blocks that right for the user or group on all secured objects within the system 5. While implementations of various technologies have been described with reference to using masks, it will be appreciated that other technologies similar to masks may be used in other implementations, such as technologies using logical user roles.

In one implementation, the policy may be applied throughout a virtual server, which may be defined as a virtual computer that resides on a server, e.g., a hypertext transfer protocol (HTTP) server, but appears to the user as a separate server. Several virtual servers may reside on one computer, each capable of running its own programs and each with individualized access to input and peripheral devices. Each virtual server may have its own domain name and IP address. Although various implementations are described herein with reference to the computer system 5 or a virtual server, other implementations may be applied to a site collection, a particular site, a library within a site or a particular item or document. As such, implementations of the various technologies described herein, including the functionality of the authorization module 46, may be applied at any level of granularity within the computer system 5.

The policy 90 may be managed by a central administrator, while the ACL 42 may be managed by a site administrator. In one implementation, the central administrator may be prohibited from accessing the ACL 42, while the site administrator is prohibited from accessing the policy 90. Thus, implementations of various technologies described herein provide a way for the central administrator to enforce uniform security policies throughout the computer system 5. Implementations of various technologies described herein also provide a way for the central administrator to delegate day-to-day security management to site administrators, while retaining the ability to control who does and does not have access to the system 5.

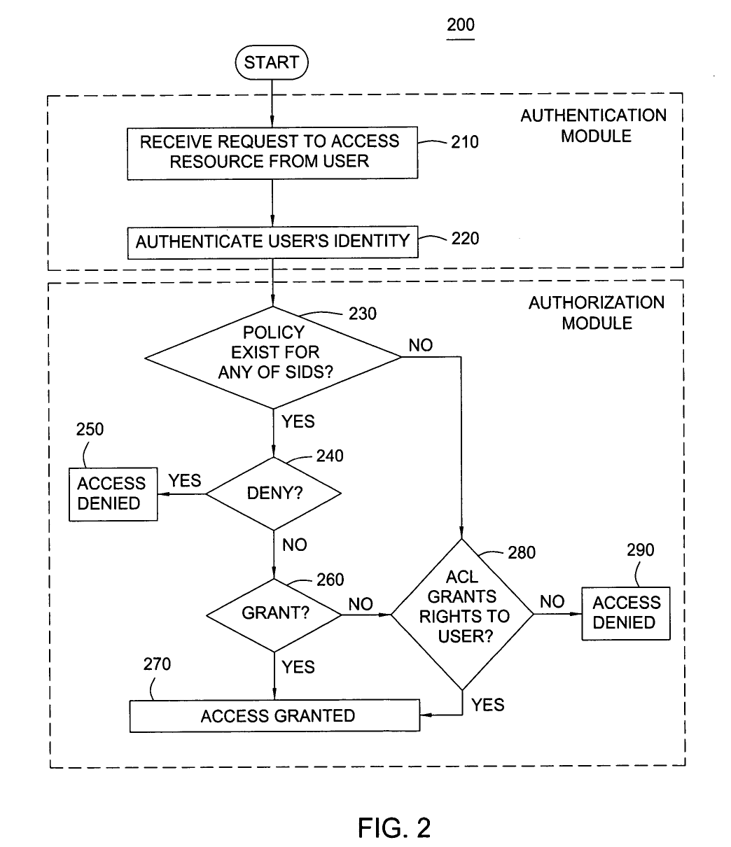

FIG. 2 illustrates a flow diagram of a method 200 for managing access to one or more objects in accordance with various implementations of the technologies described herein. At step 210, the authentication module 44 receives a request from a user to access an object. Upon receipt of the request, the user's identity is authenticated (step 220). The user's identity may be authenticated by any type of authentication process, including those that use pass words, certificates, biometrics and the like. In one implementation, the authentication module 44 reviews and authenticates all of the SIDs associated with the user (step 220). Once the user's SIDs have been authenticated, the user's rights for accessing the object may be determined by the authorization module 46. The user's rights may vary from read, insert, update, delete and the like.

At step 230, a determination is made as to whether any of the user's SIDs is specified in a policy for the computer system 5 containing the object requested. In one implementation, a determination is made as to whether the policy provides the user with rights to access the computer system 5. In another implementation, the determination is made with respect to a virtual server containing the object. If a policy does not exist, then processing continues to step 280, at which a determination is made as to whether the ACL for the object grants rights to any of the user's SIDS.

If a policy does exist, then processing continues to step 240, at which a determination is made as to whether the policy denies any of the user's SIDs rights to access the computer system 5. If the policy denies any of the user's SIDs rights to access the computer system 5, then the user is denied access to the requested object (step 250). If the policy does not deny any of the user's SIDs rights to access the computer system 5, then processing continues to step 260, at which a determination is made as to whether the policy grants any of the user's SIDs rights to access the computer system 5. If the policy grants any of the user's SIDs rights to access the computer system 5, then the user is granted access to the requested object (step 270).

On the other hand, if the policy neither denies nor grants any of the user's SIDs rights to access the object, then processing continues to step 280, at which a determination is made as to whether the ACL for the object grants any of the user's SIDs rights to access the object. If the ACL grants any of the user's SIDs rights to access the object, then the user is granted access to the requested object. However, if no ACE exists in the ACL for any of the user's SIDs, then the user is denied access to the requested object (step 290).

In this manner, if the policy denies the user the rights to access the computer system 5, then the user is denied the rights to access the object contained in the computer system 5, regardless whether the ACL grants the user the rights to access the object or not. Likewise, if the policy grants the user the rights to access the computer system 5, then the user is granted the rights to access the object, regardless whether the ACL grants the user the rights to access the object or not. As an alternative to the computer system 5, various implementations of the technologies described herein may also be applied to a virtual server containing the object.

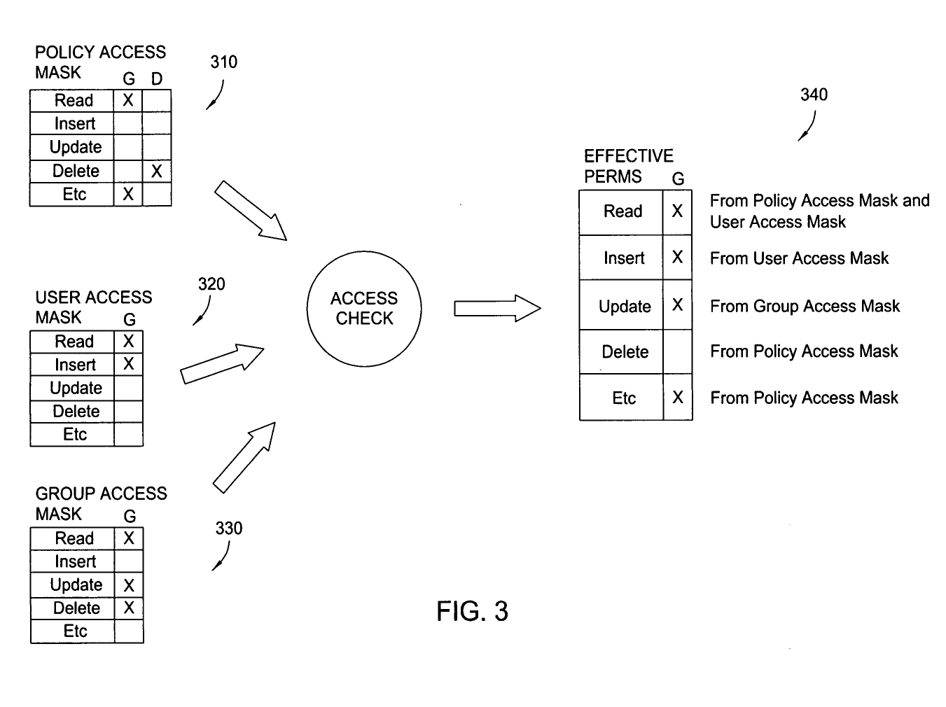

In one implementation, at run time, the access mask defined by the policy may be merged with the access mask defined by the ACL to generate an effective set of permissions for the user. FIG. 3 illustrates a flow diagram 300 of how various implementations of the technologies described herein may generate an effective set of permissions by merging the policy access mask for a system containing an object with the user access mask 320 for that object and the group access mask 330 for that object. The following description of flow diagram 300 is made with reference to method 200 of FIG. 2. However, it should be understood that the operations illustrated in flow diagram 300 are not necessarily limited to being performed by method 200. Additionally, it should be understood that while the operational flow diagram 300 indicates a particular order of execution of the operations, the operations might be executed in a different order in other implementations.

The policy access mask 310 specifies whether a particular user or group has certain rights to an object. Those rights include READ, INSERT, UPDATE, DELETE and ETC rights. ETC right may represent other rights, such as VIEW ITEM, OPEN ITEM, APPROVE ITEM, DESIGN LISTS, CREATE SUBWEBS, VIEW VERSION HISTORY, DELETE VERSIONS, MANAGE PERMISSIONS and the like. In one implementation, the policy access mask 310 specifies a set of rights that have been granted, as indicated by the check marks under the column G, and a set of rights that have been denied, as indicated by check marks under the column D. As shown in FIG. 3, the READ right is indicated as granted, the DELETE right is indicated as denied and the ETC right is indicated as granted. The policy access mask 310 makes no indication with respect to the INSERT and UPDATE rights.

The user access mask 320 specifies only rights that have been granted. For this particular example, only the READ right and the INSERT right have been granted, as indicated by the check marks under column G. Like the user access mask 320, the group access mask 330 also specifies only those rights that have been granted. For this particular example, only the READ right, UPDATE right and DELETE right have been granted, as indicated by the check marks under column G.

At run time, the policy access mask 310 is merged with the user access mask 320 and the group access mask 330 to generate an effective set of permissions 340 for the user. After the merger operation, the effective set of permissions 340 indicate that the READ right has been granted, as specified by the policy access mask 310 and the user access mask 320. The INSERT right has also been granted, as specified by the user access mask 320. The UPDATE right has also been granted, as specified by the group access mask 330. The DELETE right, however, has been denied, as specified by the policy access mask 310, even though it has been granted by the group access mask 330. Likewise, the ETC right has been granted, as specified by the policy access mask 310, even though neither the user access mask 320 nor the group access mask 330 granted access to the ETC right.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for managing a request from a user to access an object, comprising:
(a) determining whether the user is denied or granted access to the object based on a policy;
(b) if the user is neither denied nor granted access to the object by the policy, then determining whether the user is granted access to the object by an access control list (ACL) for the object; and
(c) concluding whether the user has access to the object as determined by steps (a) and (b).

2. The method of claim 1, wherein step (a) comprises determining whether the user is denied or granted access to a server that contains the object.

3. The method of claim 2, wherein the server is a virtual server.

4. The method of claim 2, wherein the server is a hypertext transfer protocol (HTTP) server.

5. The method of claim 2, further comprising denying the user access the object, if the user is denied access to the server by the policy.

6. The method of claim 5, wherein the user is denied access to the object, even if the user is granted access to the object by the ACL.

7. The method of claim 2, further comprising granting the user access the object, if the user is granted access to the server by the policy.

8. The method of claim 7, wherein the user is granted access to the object, even if the user has not been granted access to the object by the ACL.

9. A computer-readable medium having stored thereon computer-executable instructions which, when executed by a computer, cause the computer to:
(a) determine whether a policy for a server containing an object denies or grants a user access to the server;
(b) if the policy neither denies nor grants the user access to the server, then determine whether an access control list for the object grants the user access the object; and
(c) grants or denies the user access to the object based on steps (a) and (b).

10. The computer-readable medium of claim 9, further comprising computer-executable instructions which, when executed by a computer, cause the computer to deny the user access the object, if the policy denies the user access to the server.

11. The computer-readable medium of claim 9, further comprising computer-executable instructions which, when executed by a computer, cause the computer to grant the user access to the object, if the policy grants the user access to the server.

12. The computer-readable medium of claim 9, wherein the server is a virtual server.

13. The computer-readable medium of claim 9, wherein the server is a hypertext transfer protocol (HTTP) server.

14. A memory for storing data for access by an application program being executed on a processor, the memory comprising: a data structure stored in the memory, the data structure comprising an access mask for a server, the access mask specifying one or more permissions for at least one of granting or denying access to the server.

15. The memory of claim 14, wherein the server is a virtual server that resides on a hypertext transfer protocol (HTTP) server.

16. The memory of claim 14, wherein the server is a hypertext transfer protocol (HTTP) server.

17. The memory of claim 14, wherein the access mask comprises a set of grant access masks for specifying a predetermined set of users that are granted access to the server.

18. The memory of claim 14, wherein the access mask comprises a set of deny access masks for specifying a predetermined set of users that are denied access to the server.

19. The memory of claim 14, wherein the data structure further comprises an access control list for an object contained within the server.

20. The memory of claim 19, wherein the access control list comprises a set of grant access masks for specifying a predetermined set of users that are granted access to the object.
